(19) United States
(12) Patent Application Publication
(10) Pub. No.: US 2014/0102982 A1
(43) Pub. Date: Apr. 17, 2014

(54) Semipermeable Membrane and Process Using Same

(71) Applicant: NUWATER RESOURCES INTERNATIONAL, LLC, Natick, MA (US)

(72) Inventor: Paul William Fairchild, Socorro, NM (US)

(73) Assignee: NUWATER RESOURCES INTERNATIONAL, LLC, Natick, MA (US)

(21) Appl. No.: 14/056,595

(22) Filed: Oct. 17, 2013

Related U.S. Application Data
(60) Provisional application No. 61/715,131, filed on Oct. 17, 2012.

(51) Int. Cl. B01D 63/08; C02F 1/44; B01D 61/00

(52) U.S. Cl. CPC B01D 63/087; B01D 61/002; C02F 1/445
USPC 210/644; 210/456; 210/321.72; 210/650

(57) ABSTRACT

An enhanced process for semipermeable membrane performance. Counter flowing chambers on either side of a semipermeable membrane is disclosed. Each comprise turbulent flow injectors and flow deflector cells giving rise to swirling and turbulent boundary layer conditions. The disclosed invention obviates concentration polarization in osmotic systems and maximizes flux (fluid flow) through the semipermeable membrane. This invention fills a need in large volume, forward osmosis water purification systems.

### RELATED APPLICATIONS

This application is related to and claims priority of U.S. Provisional Application No. 61/715,131 entitled, “An Enhanced Process for Semipermeable Membrane Performance” filed on Oct. 17, 2012, which is hereby incorporated by reference in its entirety.

### TECHNICAL FIELD

The present application is directed to water purifying osmotic systems with means for promoting turbulence to scour a membrane surface to prevent concentration polarization and skinning (false membrane formation) as well as other contaminant build up on the membrane. These valuable results are attained by a novel circulatory system in concert with a cell structures disposed near a semipermeable membrane that produced the turbulence.

### BACKGROUND

This invention relates to continuous filtering processes. More particularly, the invention is akin to forward osmosis and associated problems with semipermeable membranes and cross-flow filtration. In Chemical Engineering, water purification, and protein purification, cross-flow filtration (also known as tangential flow filtration) is a type of filtration (a particular unit operation); whereby, the majority of the feed flow travels tangentially across the surface of the filter, rather than into the filter.

This is different from dead-end filtration in which the feed is passed through a membrane or bed; whereby, the solids being trapped in the filter and the filtrate get released at the other end. The principal advantage of cross-flow filtration is that the filter cake (which can blind or otherwise foul the filter) is substantially washed away during the filtration process, increasing the length of time that a filter unit can be operational. It can be a continuous process, unlike batch-wise dead-end filtration.

However, there remain inherent problems associated with cross-flow filtration. Specifically, in osmotic systems, a condition called concentration polarization can occur. Osmosis is the spontaneous net movement of solvent molecules through a partially permeable or semipermeable membrane into a region of higher solute concentration. The net movement follows a direction that tends to equalize the solute concentrations on the two sides, even in system with a plurality of disparate species.

Forward osmosis is a physical process in which any solvent moves without input of externally applied energy across a semipermeable membrane. The membrane is permeable to the solvent but not the solute. It separates two solutions of different concentrations. Although forward osmosis does not require input of energy, it does use kinetic energy and can be made to do work using osmotic pressure.

Osmotic pressure is defined to be the pressure required to maintain an equilibrium, with no net movement of solvent. Osmotic pressure is a colligative property, meaning that the osmotic pressure depends on the molar concentration of the solute but not on its identity. Thus, a semipermeable membrane could separate two differing solutes in solution. Yet, the membrane could be permissive to one or neither of the species in order to give rise to an osmotic pressure. This will be discussed in greater detail later.

The buildup of solutes that are unable to cross the membrane surface is referred to as concentration polymerization. As a result, one side of the membrane wall has a higher solute concentration than the other side. Concentration polarization is affected by both membrane and solute properties, as well as transverse and axial flow fields. Concentration polarization has a substantial effect on the overall performance of the reverse osmosis process and is used to predict surface scale formation.

The increased concentration gradient across the membrane increases the solute flux through the membrane. Once the solubility limit is exceeded, concentration polarization causes solute precipitation. This leads to both particle fouling and surface scale formation. Also, the increased osmotic pressure at the membrane wall lowers the solution flux. Both membrane fouling and solution flux reduction are exacerbated by the accumulation of material in the feed blocking the surface of the membrane.

Another form of concentration polarization is the initial buildup of solvent molecules that are adjacent to the membrane after passing said membrane. During this initial period the concentration if very similar on both side of the membrane thus reducing the osmotic potential and slowing the rate of transmission through the membrane.

Previous methods at reducing concentration polarization have either been based on mechanical stirring or mechanical vibration. The process of mechanically stirring the liquid typically comprises one or more paddles (or similar) on either or both sides of the membrane. However, this results in a slow movement of flow and, consequently, retarded flux.

The present state of the art of mechanical stirring the liquid can prevent contaminant buildup. One object of the present invention affords enclosing the system or draw channel. But, the mechanical paddle (or similar device) precludes enclosing the system, in part due to the mechanically coupled motors. Thus, mechanical paddles maybe technologically simple but difficult to implement in small or narrow chambers. The issue of enclosure is further complicated in that paddle rate is dependent on contaminant concentration. What is more is that they introduce added complexity such that one more components can fail.

It is advantageous to enclose the membrane area to prevent evaporation loss of draw solution. To this end, mechanical vibration of the membrane or mechanical structure has been attempted. Hitherto, mechanical vibration has not been successful. In theory, mechanical vibration prevents contaminant buildup by propagating a low frequency vibration on the membrane or mechanical structure. It, however, requires a relatively large amplitude of vibration to cause the contaminants to be physically displaced from the membrane surface and therefore does not adequately solve the concentration polarization problem in highly contaminated solutions.

The invention reduces the need for mechanical additions such as a paddle for stirring or a low frequency oscillator for vibration, while minimizing contaminates that can build-up on the membrane surface slowing the osmosis process. The present disclosure contemplates new and improved systems and/or methods for remedying these, and other, problems.

### SUMMARY

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure will be set forth in the following detailed description of the disclosure when considered in conjunction with the drawings.

As mentioned above, the present invention relates to a novel and improved continuous filtering process, and more particularly, to a continuous filtering process which permits cells of turbulent mixing proximate to a semi-permeable membrane thereby mitigating concentration polarity. The present invention also discloses to a novel filtering apparatus suitable for carrying out such filtering process.

According to one aspect of the invention, a water filtration system comprises a semipermeable membrane, a feed channel, and a draw channel disposed on each side of the semipermeable membrane. The water filtration system also comprises flow deflectors on at least on side of the semipermeable membrane.

According to another aspect of the present invention, the water filtration system further comprises at least one nozzle which direction water flow across the plurality of flow deflector to generate turbulence. According to another aspect, a valve controls the feed flow to the nozzle.

According to one or more aspects, the valve receives water from pump. In another aspect, the pump receives water via a reservoir, which is also connector to the egress of feed channel of the water filtration system.

According to yet another aspect, the water system further comprises a corresponding valve, nozzle, pump, and reservoir for the draw channel side.

### IN THE DRAWINGS

FIG. 1 illustrates an exemplary membrane interaction and a graphical distribution of chemical species;

FIG. 2 depicts an exemplary turbulent cell;

FIG. 3 illustrates an exemplary cellular membrane disposed in draw and feed chambers;

FIG. 4 illustrates an exemplary filtration system;

FIG. 5 depicts an exemplary turbulent cell according to an alternate embodiment; and

FIG. 6 illustrates a reverse osmosis according to an alternate embodiment.

### DETAILED DESCRIPTION

As mentioned above, the present invention relates to new and improved methods and apparatus for a filtration system, which is effective at mitigating concentration polarization with a semipermeable membrane. One or more embodiments or implementations are hereinafter described in conjunction with the drawings, where like reference numerals are used to refer to like elements throughout, and where the various features are not necessarily drawn to scale.

Concentration polarization refers to the concentration gradient of salts on the high-pressure side of an osmosis membrane surface. The gradient is created by the delay in redilution of salts left behind as water permeates through the membrane itself. The salt concentration in this boundary layer exceeds the concentration of the bulk water. This phenomenon affects the performance of the forward osmosis process by increasing the osmotic pressure at the membrane's surface. Consequently, the gradient engenders reduced flux, an increase in salt leakage and possible scale development.

Osmosis uses solution-diffusion for mass transport through a semipermeable membrane. These membranes are generally impermeable to large and polar molecules, such as ions, proteins, and polysaccharides. At the same time they can be designed to be permeable to a wide variety of polar and non-polar and/or hydrophobic molecules like lipids as well as to small molecules like oxygen, carbon dioxide, nitrogen, nitric oxide, etc. Permeability depends on solubility, charge, or chemistry, as well as solute size. Biologically, osmosis provides the primary vehicle by which water is transported into and out of a cell.

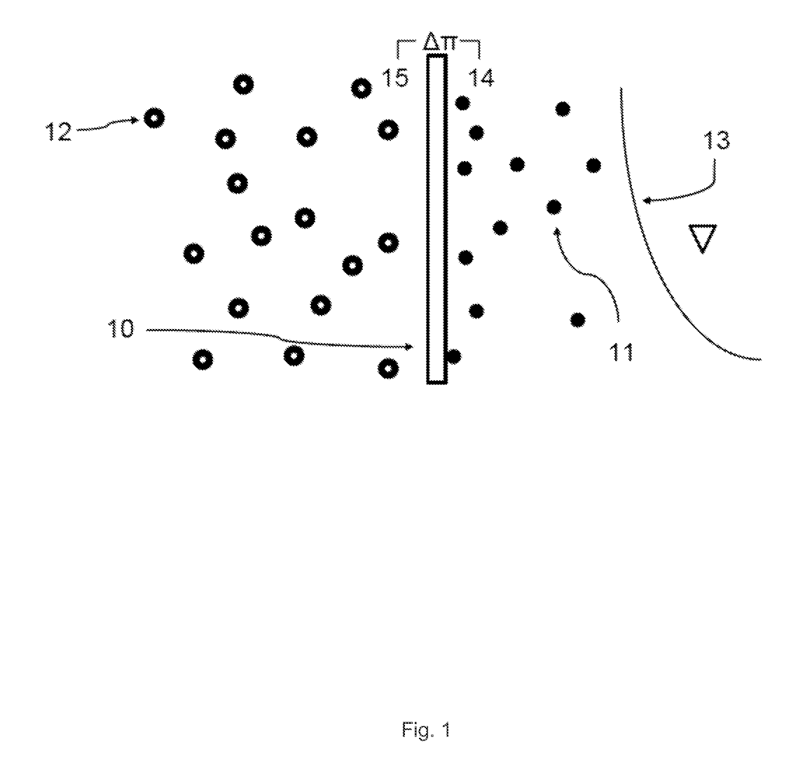

FIG. 1 illustrates an exemplary semipermeable membrane 10 interaction and a graphical distribution of chemical species, according to one embodiment of the present invention. In the solution-diffusion model, which characterizes osmosis, mass transport occurs by diffusion. The feed solution 14 is an aqueous solution high in dissolved salts, which is a common application of water purification systems (e.g., desalination, etc.).

In the present embodiment, the solute is mostly dissociated sodium chloride 11. But the solution contain can other chemical species as well and not be detrimental to the process, dissolved, dissociated (ions) or otherwise. The membrane is chosen to be permeable to water molecules. The molarity of the feed solution 14 is order of 1.5M but can be anything under super-saturation. It is the relationship (proportionality) between the feed solution 14 and the draw solution 15 which governs the forward solute separation, at least in part.

In the present embodiment, the draw solution 15 comprises aqueous (NH₄)HCO₃ (ammonium bicarbonate). A 3-4M solution is prepared by dissolving ammonium bicarbonate 12 into distilled water. Ammonium bicarbonate (in a powdered or granular form) dissolves readily in water to make a solution containing ammonia, NH₃ (or ammonium ion, NH₄⁺), carbon dioxide, CO₂ and bicarbonate, HCO₃⁻. The molarity of the ammonium bicarbonate is best chosen to be about 2M higher than the water on the feed side to maximize the osmotic potential.

The disparity of molarities between feed solution and draw solution 15 is the driving force for the separation by creating an osmotic pressure gradient. The draw solution 15 of high concentration (relative to that of the feed solution 14) is used to induce a net flow of water through the semipermeable membrane 10 into the draw solution 15, thus effectively separating the feed water from sodium chloride 11.

Heuristically, the relationship between osmotic and hydraulic pressures and water flux is:

J_{w}=A(Δπ−ΔP)

where J_{w} is water flux, A is the hydraulic permeability of the membrane, Δπ is the difference in osmotic pressures on the two sides of the membrane, and ΔP is the difference in hydrostatic pressure (negative values of J_{w} indicating reverse osmotic flow).

Water egresses feed solution 14 by flowing through semipermeable membrane 10 and ingresses draw solution 15 thereby diluting it. In the present embodiment and devoid of external pressure or pumping, the pressure difference, ΔP, between feed solution 14 and draw solution 15 is simply the osmotic pressure difference, Δπ; such that, Δπ=ΔP.

In one or more embodiments, a distillation system then removes dissolved ammonia and carbon dioxide resulting in purified water. However, it is not beyond the scope of the present to use any other suitable method for removal of NH₄⁺ and CO₂, such as, simple outgassing pursuant to Henry's law.

During the filtration process a boundary layer forms on the membrane. This concentration gradient 13 is created by molecules or ions (NaCl 11), which cannot pass through the semipermeable membrane 10. The effect is referred as concentration polarization. During the filtration, it leads to a reduced trans-membrane flow (flux). Referring to FIG. 1, concentration gradient 13 is graphically depicted as a function of concentration vs. displacement. It can be seen that a large concentration of sodium chloride 11 is disposed proximate to semipermeable membrane 10.

Concentration polarization is, in principle, reversible by cleaning the membrane, which results in the initial flux being almost totally restored. This is impractical in constant flow purification system. Using a tangential flow to the membrane (cross-flow filtration) is frequently used to minimize concentration polarization. Increasing the velocity (turbulence) of the brine stream also helps to reduce the concentration polarization, which is an object of the present invention.

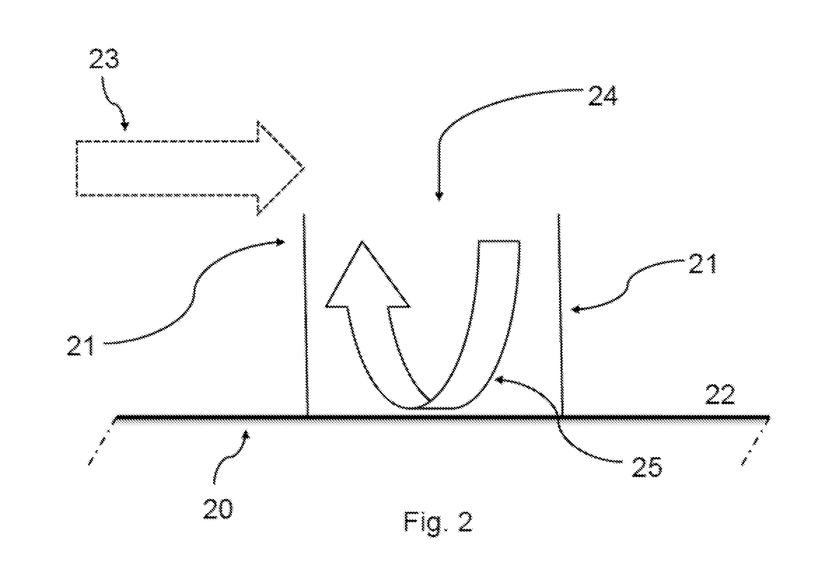

FIG. 2 depicts an exemplary turbulent cell 24 according to one embodiment. An injection nozzle or similar mechanism produces a vector flow 23 in a direction orthogonal to the aperture of turbulent cell 24. Vector flow 23 imparts a swirl 25 to the input flow 22 causing turbulence. Turbulent cell 24 comprises mechanical ribs 21 which, at least in part, deflect the tangentially flowing solution. Mechanical ribs 21 are abutted to semipermeable membrane 20 to enclose the structure on the distally from the vector flow 23.

In conjunction, swirl 25 and subsequent turbulence vastly mitigates concentration polarization preventing build up. This is an improvement over previous forward osmosis devices whereby, the water to be cleaned is brought in contact with the membrane and is either left static against the membrane or there is a mechanical device like a paddle wheel to keep the high concentration from building up on the membrane surface by sweeping the liquid.

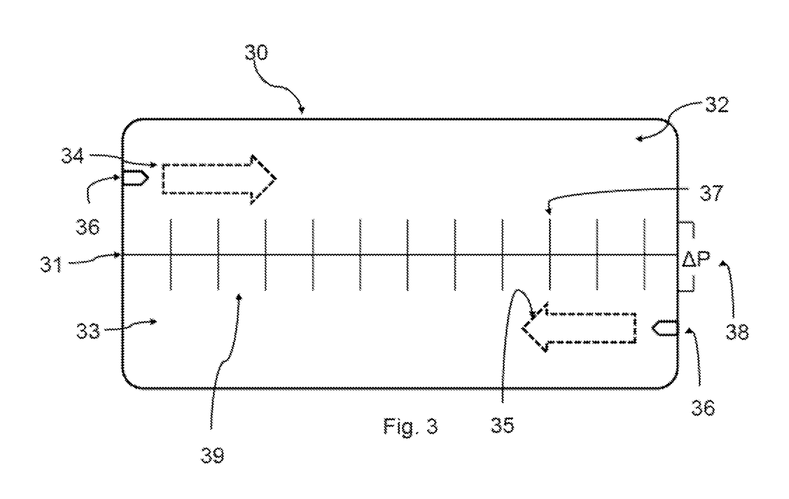

FIG. 3 illustrates an exemplary enclosed cellular membrane system 30. Enclosed cellular membrane system comprises counter flowing chambers 32, 33 on either side of a semipermeable membrane 31. Flow injectors 36 produce counter flowing streams 34, 35 in net directions opposite to one another and tangential to semipermeable membrane 31. Flow injectors 36 can be nozzles or any other volume reducing device.

Mechanical ribs 37 coordinate to generate flow deflecting cells 39 that create turbulence via counter flowing streams 34, 35. The generated turbulence helps to keep build-up contaminants off the surface of the membrane which results in fouling. By removing concentration polarization, the resulting difference in pressure 38 between feed chamber 33 and draw chamber 32 is simply a function of water flux through the semipermeable membrane 31 (and its hydraulic permeability), the ingressing/egressing counter flowing streams 34, 35, and differences in osmotic pressure in counter flowing chambers 32, 33.

In one or more embodiments, counter flowing chambers 32, 33 comprise feed and draw flow channels. Dimensionally, these are a few inches wide by a few inches high by several feet long separated by semipermeable membrane 31. Semipermeable membrane is made of cellulous tri acetate (CTA) or any other suitable material known in the art. The enclose itself and mechanical ribs 37 can be made from any rigid material including, but not limited to, metal, plastics, polymer, polyethylene terephthalate (PET), polyvinyl chloride (PVC), etc.

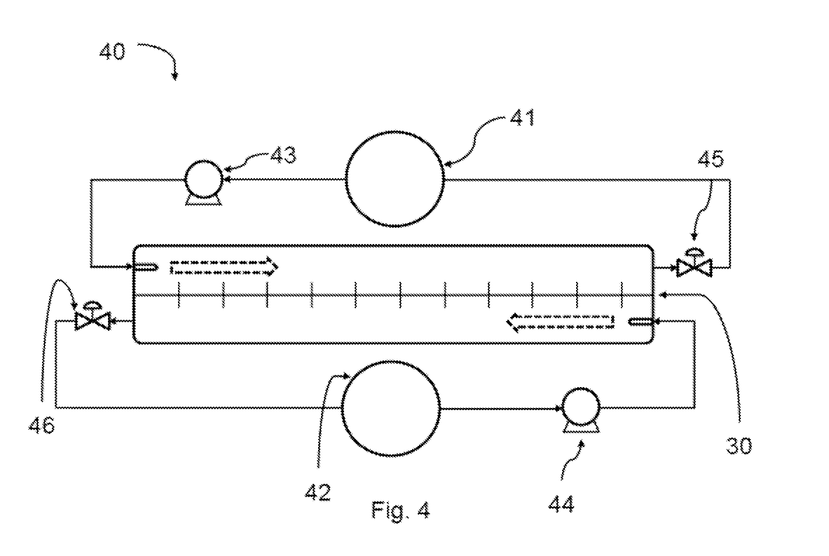

Turning to FIG. 4, an exemplary filtration system 40 is illustrated. Enclosed cellular membrane system 30 comprises two simple flow channels, pursuant to the discussion associated with FIG. 3. The flows of the feed and draw are set such that they are in counter flowing directions parallel to the membrane. The inlet/output ports of these flows consist of a nozzle that imparts a side or deflected component to the direction of the flow causing turbulence. If the chamber is made too long for the particular flow conditions such tha the initially turbulent flow starts to become laminar along the membrane appropriate flow displacement deflectors can be inserted to break-up the laminar flow properties.

Filtration system 40 further comprises draw and feed reservoirs 41, 42, respectively. Draw and feed reservoirs 41, 42 can be large storage volumes or smaller batch tanks which act in the capacity as pressure buffers. Draw and feed reservoir 41, 42 supply draw and feed solution to draw and feed pumps 43, 44, respectively. Draw and feed pumps 43, 44 circulate draw and feed solutions in a looped manner through the enclosed cellular member system 30.

Volumes and pressures are controlled by draw and feed valves 45, 46, respectively, which regulate the flow of the draw and feed solutions. Draw and feed valves 45, 46 can be mechanical (reed, ball, etc.), electromechanical, pneumatic or even hydraulically activated. In an alternate embodiment, draw and feed valve are regulators, which are known in the art. In yet another embodiment, any combination of the following can be replaced by feedback controlled impeller(s): draw and feed valves 45, 46; draw and feed pumps 43, 44; and/or flow injectors 36 (disposed in its place).

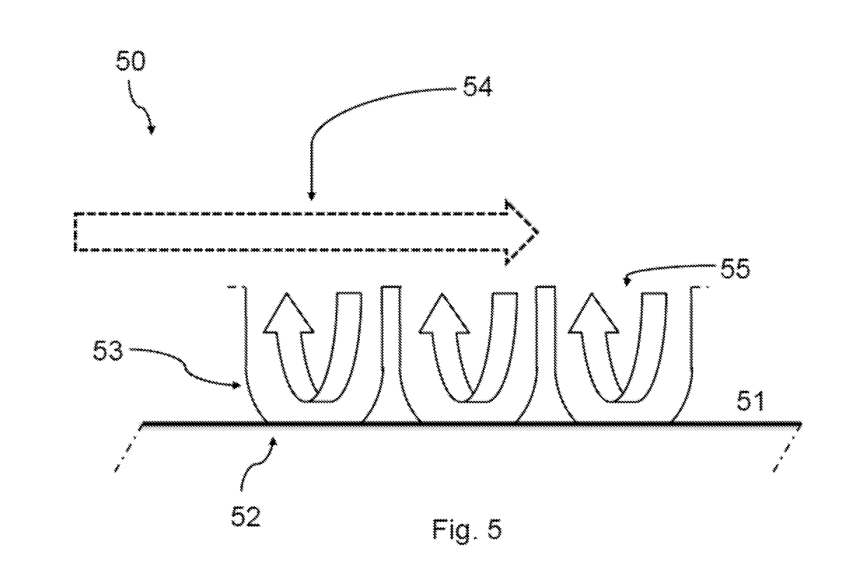

FIG. 5 depicts exemplary turbulent cells 50, according to an alternate embodiment. Turbulent cells 50 function similarly to previously described. However, these are fabricated in manner, which lends to a naturally turbulent form. Flow deflectors 53 are a significantly concave/rounded shape thereby facilitating swirling 53 proximate to the semipermeable membrane 52.

In one or more embodiments, flow deflectors 53 comprise a material to transition the tangential flow 54 from laminar to turbulent, such as dimpling. The turbulent boundary creates a narrow low-pressure wake. The reduction in pressure further permits flux through the membrane. In another embodiment, the flow channels are hourglass shaped to engender a Bernoulli effect also generating a low-pressure zone.

In other embodiments, the placement and component materials of the ribs and nozzles can be varied and remain within the scope of the current invention. For example, a plurality of nozzles can be used to effect tangential flow. Additionally, there can be several alternating flow channels to increase the volume of water which passes through the membrane.

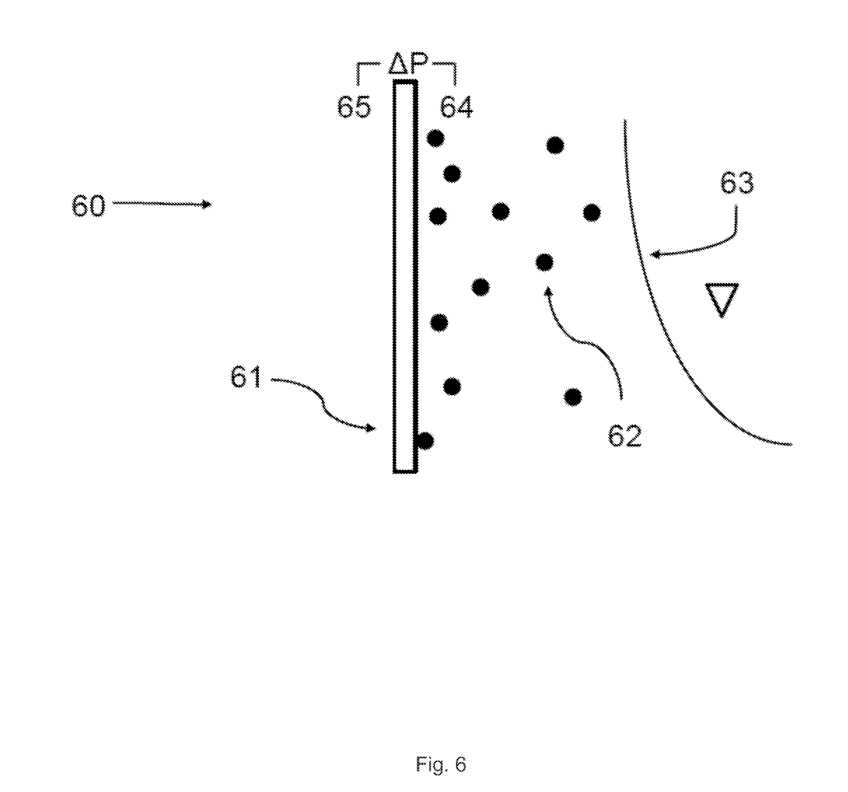

FIG. 6 illustrates an exemplary single specie membrane system 60 according to an alternate embodiment. The present invention can also be used on a reverse osmosis configuration, which would obviate the need for bicarbonate salt. However, in the present embodiment, the osmotic pressure favors the saturated salt 62 side of the semipermeable membrane 61.

In reverse osmosis, an applied pressure is used to overcome osmotic pressure which is a colligative property. Reverse osmosis can remove many types of molecules and ions (saturated salt 62) from solutions and is used in both industrial processes and in producing potable water. The result is that the solute (saturated salt 62) is retained on the pressurized feed side 64 of the membrane and the pure solvent is allowed to pass to the draw side 63.

Yet, reverse osmosis still suffers from concentration polarity and exhibits a gradient 63 proximate to the semipermeable membrane 61. Reverse osmosis can be implemented through increasing the feed pump flow/pressure or constricting the flow on the draw valve. Therefore, even though the prior embodiments were characterized in the context of forward osmosis, reverse osmosis (and filtration processes based hydrodynamic model) is not beyond the scope of the present invention.

The embodiments described and illustrated herein are not meant by way of limitation, and are rather exemplary of the kinds of features and techniques that those skilled in the art might benefit from in implementing a wide variety of useful products and processes. For example, in addition to the applications described in the embodiments below, those skilled in the art would appreciate that the present disclosure can be applied to wastewater treatment, chemical engineering application, reclamation water treatment, or desalination pretreatment systems. However, it is to be appreciated that the present exemplary embodiments are also amenable to other like applications.

The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure. The claims are intended to cover such modifications and equivalents.

Another factor this invention improves is that when initially when solvent molecules pass through the membrane going from a low concentration side to a high concentration side. As soon as they enter the high concentration side and are still against the membrane surface and for a low concentration layer in the high concentration side, the osmotic potential is lowered since to the membrane the concentrations on both sides are nearly equal. Having turbulent flow will quickly stir and effective disperse this low concentration layer.

What is claimed is:

1. A filtration apparatus comprising:
a semipermeable membrane;
a first plurality of deflectors disposed adjacent and substantially orthogonally to the semipermeable membrane; and,
a first nozzle;
wherein, the first nozzle is configured to generate a flow whose direction is substantially coaxial to the semipermeable membrane and orthogonally to the first plurality of deflectors.

2. The filtration apparatus of claim 1, said apparatus is enclosed in its entirety to mitigate evaporation.

3. The filtration apparatus of claim 1, further comprising:
a feed channel disposed on one side of the semipermeable membrane; and,
a draw channel disposed on the other side of the semipermeable membrane;
wherein, the flows of the feed channel and the draw channel are in opposite directions.

4. The filtration apparatus of claim 3, wherein the first plurality of deflectors is disposed in the feed channel; and, further comprising a second plurality of deflectors disposed in the draw channel.

5. The filtration apparatus of claim 4, further comprising a second nozzle; wherein, the second nozzle is configured to generate a flow whose direction is substantially coaxial to the semipermeable membrane and orthogonally to the second plurality of deflectors.

6. The filtration apparatus of claim 5 further comprising a first pump in hydraulic communication with the feed channel.

7. The filtration apparatus of claim 6 further comprising a first valve in hydraulic communication with the feed channel.

8. The filtration apparatus of claim 7 further comprising a first reservoir in hydraulic communication with the feed channel.

9. The filtration apparatus of claim 8 further comprising a second pump in hydraulic communication with the draw channel.

10. The filtration apparatus of claim 9 further comprising a second valve in hydraulic communication with the draw channel.

11. The filtration apparatus of claim 10 further comprising a second reservoir in hydraulic communication with the draw channel.

12. A method for a solution filtration system comprising the steps of:
forming a semipermeable membrane with a feed side and draw side;
abbutting a first plurality of deflectors against the feed side of the semipermeable membrane;
providing a first nozzle;
whereby, the first nozzle is provided to generate a flow whose direction is substantially coaxial to the semipermeable membrane and orthogonally to the first plurality of deflectors.

13. The method of claim 12, further comprising abutting a second plurality of deflectors against the draw side of the semipermeable membrane.

14. The method of claim 13, further comprising providing a second nozzle is configured to generate a flow whose direction is substantially coaxial to the semipermeable membrane and orthogonally to the second plurality of deflectors.

15. The method of claim 14, further comprising:
flowing solution in the feed side; and,
flowing solution counter directionally in the draw side.

16. The method of claim 15, further comprising connecting a pump to feed side.

17. The method of claim 16, further comprising disposing a valve in between the pump and feed side.

18. The method of claim 17, further comprising providing a reservoir in hydraulic communication with feed side.
